(19) United States
(12) Patent Application Publication
(10) Pub. No.: US 2007/0121711 A1
(43) Pub. Date: May 31, 2007

(54) PLL with programmable jitter for loopback serdes testing and the like

(76) Inventors: Glen E. Offord, Macungie, PA (US); Phillip L. Johnson, Hellertown, PA (US)

Correspondence Address: MENDELSOHN AND ASSOCIATES, P.C., 1500 JOHN F. KENNEDY BLVD., SUTIE 405, PHILADELPHIA, PA, 19102, US

(21) Appl. No.: 11/289,892

(22) Filed: Nov. 30, 2005

(51) Int. Cl. H04L 5/16

(52) U.S. Cl. 375/219

(57) ABSTRACT

In one embodiment of the invention, a phase-locked loop (PLL) can be programmably controlled to add jitter to its PLL output clock. Such a PLL can be used to programmably inject jitter into the outgoing serial data signal generated by a serializer/de-serializer (serdes) that can be operated in an internal loopback mode, in which the outgoing serial data signal is internally looped back from the transmitter side of the serdes to the serdes receiver side. Jitter logic associated with the PLL can be operated in a register-based mode that does not rely on any externally generated jitter clock. Such register-based processing enables effective (1) internal loopback testing of unpackaged devices at the wafer stage as well as package devices at the package stage and (2) external loopback testing at the system level.

### TECHNICAL FIELD

The present invention relates generally to semiconductor devices, such as application-specific integrated circuits (ASICs) and field-programmable gate arrays (FPGAs), and, in particular, to the input/output (I/O) interfaces for such devices.

### BACKGROUND

A serializer/de-serializer (serdes) is a standard I/O circuit for certain semiconductor devices, such as FPGAs and the like. For applications in which a semiconductor device is designed to operate at I/O signaling rates that are greater than the internal operating speed of its data processing logic, a serdes is used to convert a high-speed received serial data signal into a lower-speed parallel data signal for internal processing. A serdes is also used to convert a low-speed outgoing parallel data signal into a higher-speed serial data signal for output transmission.

A clock-and-data recovery (CDR) circuit is another standard input circuit for semiconductor devices. A CDR circuit processes a received modulated signal to recover both the data encoded in the signal as well as a clock signal corresponding in frequency and phase to the clock signal used to generate the modulated signal at its transmitter.

The operations of serdes and CDR circuits are susceptible to jitter (e.g., random variations in the phase and/or frequency of the signals). Typically, the operations of serdes and CDR circuits are not effectively tested at either the wafer stage or the package stage of manufacturing using automatic test equipment (ATE), including ATE testing that involves an internal loopback mode in which the outgoing serial data signal from the transmitter is internally looped back within the integrated circuit to the receiver as the incoming serial data signal. As a result, devices that pass ATE testing may ultimately fail to operate in standard customer applications, resulting in unsatisfied customers.

### SUMMARY

In one embodiment, the present invention is an integrated circuit having a serializer/de-serializer (serdes) comprising a transmitter and a receiver. The transmitter serializes an outgoing parallel data signal to generate an outgoing serial data signal, and the receiver de-serializes an incoming serial data signal to generate an incoming parallel data signal. The serdes supports an internal loopback mode in which the outgoing serial data signal from the transmitter is internally looped back within the integrated circuit to the receiver as the incoming serial data signal. The transmitter programmably injects jitter into the outgoing serial data signal.

In another embodiment, the present invention is an integrated circuit having a phase-locked loop (PLL) comprising a voltage-controlled oscillator (VCO), a loop filter, a charge pump, a phase/frequency detector (PFD), a programmable jitter circuit, and jitter logic. The VCO generates a PLL output clock based on a voltage at an input node of the VCO. The loop filter generates the voltage at the VCO input node. The charge pump selectively adds charge to or subtracts charge from the loop filter. The PFD compares a feedback clock based on the PLL output clock to a PLL reference clock to generate pump control signals for controlling the charge pump. The programmable jitter circuit programmably adds additional charge to or subtracts additional charge from the loop filter based on jitter control signals. The jitter logic generates the jitter control signals to control operations of the programmable jitter circuit.

In yet another embodiment, the present invention is a method for testing an integrated circuit having a serdes comprising a transmitter and a receiver. The transmitter serializes an outgoing parallel data signal to generate an outgoing serial data signal, and the receiver de-serializes an incoming serial data signal to generate an incoming parallel data signal. The serdes supports an internal loopback mode in which the outgoing serial data signal from the transmitter is internally looped back within the integrated circuit to the receiver as the incoming serial data signal. The transmitter programmably injects jitter into the outgoing serial data signal. The method comprises configuring the serdes into the internal loopback mode and programming the transmitter to inject jitter into the outgoing serial data signal.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 shows a high-level block diagram of the layout of an exemplary FPGA of the present invention;

FIG. 2 shows a block diagram of the architecture of a serializer/de-serializer circuit that can be implemented as part of the I/O circuitry of the FPGA of FIG. 1, according to one embodiment of the present invention; and

FIG. 3 shows a block diagram of the control registers, jitter logic, and PLL circuit of FIG. 2, according to one embodiment of the present invention.

### DETAILED DESCRIPTION

FPGA Architecture

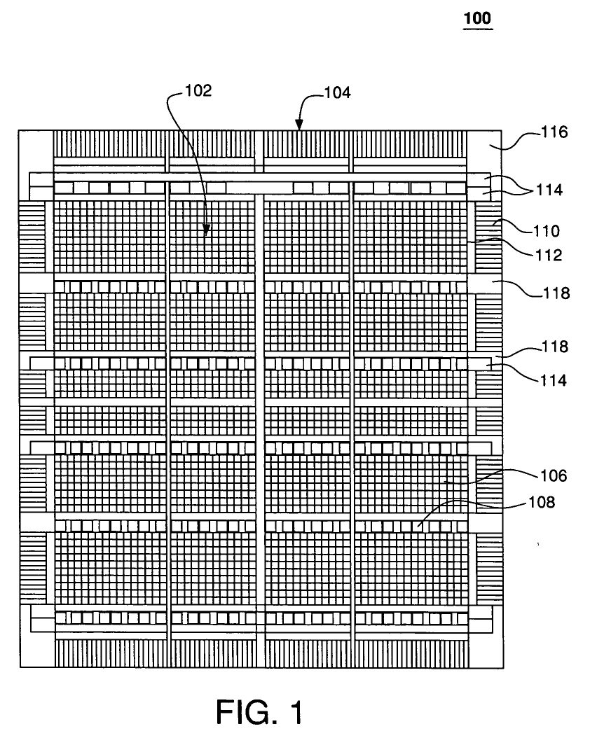

FIG. 1 shows a high-level block diagram of the layout of an exemplary FPGA 100 of the present invention, having a logic core 102 surrounded by an input/output (I/O) ring 104. Logic core 102 includes an array of programmable logic blocks (PLBs) 106 (also referred to in the art as programmable logic cells, logic array blocks, or configurable logic blocks) intersected by rows of block memory 108. Each PLB contains circuitry that can be programmed to perform a variety of different functions. The memory blocks in each row are available to store data to be input to the PLBs and/or data generated by the PLBs. I/O ring 104 includes sets of I/O buffers 110 programmably connected to the logic core by multiplexor/demultiplexor (mux/demux) circuits 112. The I/O buffers support external interfacing to FPGA 100. Also located within the I/O ring are a number of phase-locked loop (PLL) circuits 114 that are capable of providing different timing signals for use by the various elements within FPGA 100. Those skilled in the art will understand that FPGAs, such as FPGA 100, will typically include other elements, such as configuration memory, that are not shown in the high-level block diagram of FIG. 1. In addition, general routing resources, including clocks, buses, general-purpose routing, high-speed routing, etc. (also not shown in FIG. 1), are provided throughout the FPGA layout to programmably interconnect the various elements within FPGA 100.

The layout of an FPGA, such as FPGA 100 of FIG. 1, comprises multiple instances of a limited number of different types of blocks of circuitry. For example, an I/O ring may contain a number of instances of the same basic block of circuitry repeated around the periphery of the device. In the example of FPGA 100, I/O ring 104 is made up of multiple instances of the same basic programmable I/O circuit (PIC), where each PIC provides a particular number of the I/O buffers of the I/O ring.

Serdes Architecture

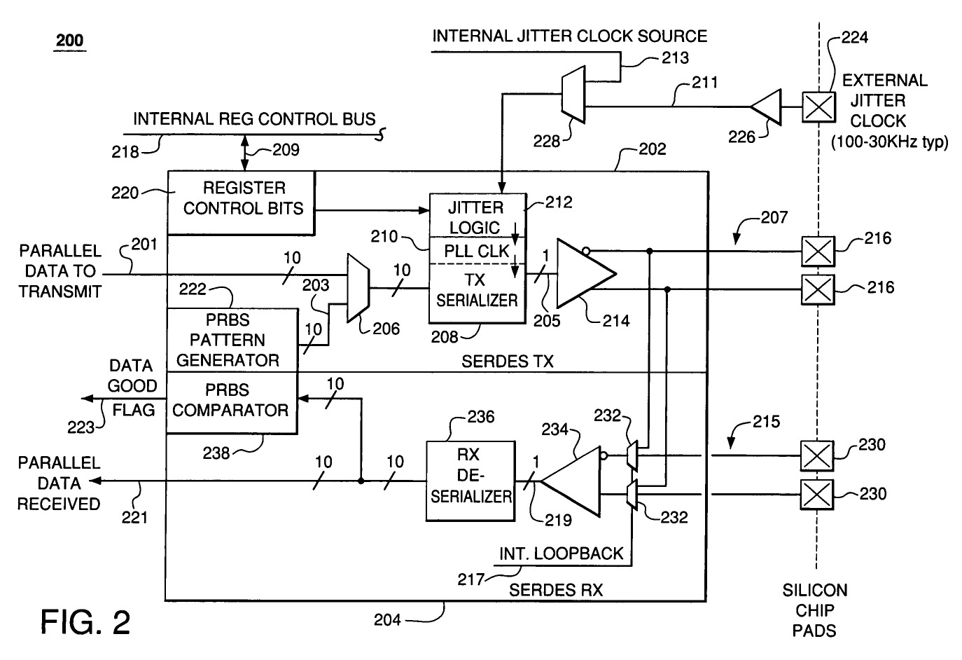

FIG. 2 shows a block diagram of the architecture of a serdes circuit 200, which can be implemented as part of the I/O circuitry of FPGA 100 of FIG. 1, according to one embodiment of the present invention. Serdes 200 includes transmitter (TX) 202 and receiver (RX) 204.

Within TX 202, TX serializer 208 converts a 10-bit outgoing parallel data signal 201 into serial data signal 205, and differential TX buffer 214 converts serial data signal 205 into outgoing serial differential data signal 207, which is presented at output pads 216.

Within RX 204, differential RX buffer 234 converts an incoming serial differential data signal 215 applied to input pads 230 into serial data signal 219, and RX de-serializer logic 236 converts serial data signal 219 into a 10-bit incoming parallel data signal 221.

As indicated in FIG. 2, serdes 200 supports an internal loopback mode in which, in addition to being presented at output pads 216, outgoing data signal 207 is applied to an input port of each 2:1 mux 232 in RX 204, which also receives a different half of incoming differential data signal 215 at its other input port. Each mux 232 receives an internal loopback control signal 217 at its control port to determine which input signal is selected for provision to RX buffer 234. When internal loopback mode is selected, the outgoing signals generated by TX 202 are internally looped back to and processed by RX 204. This internal loopback mode can be used to test the operations of serdes 200 as well as other circuitry connected downstream of incoming parallel data signal 221 within FPGA 100.

Rather than using outgoing parallel data signal 201, such testing can be implemented using known sets of standardized test data, such as pseudo-random bit sequence (PRBS) parallel data signal 203, generated by PRBS pattern generator 222 and injected into the outgoing path using mux 206 within TX 202. Within RX 204, PRBS comparator 238 compares incoming data signal 221 to PRBS data signal 203 to determine whether incoming data signal 221 matches PRBS data signal 203 (as indicated by “data good” flag 223).

Serdes 200 supports testing of circuitry during the internal loopback mode with simulated jitter. As indicated in FIG. 2, serdes 200 supports three different sources of simulated jitter: (1) external jitter clock 211 applied at input pad 224 and routed via input buffer 226 and mux 228, (2) internal jitter clock 213 from an internal clock source (not shown) and routed via mux 228, and (3) control bits 209 from internal register control bus 218 and routed via control registers 220 within TX 202.

In each case, simulated jitter is added to outgoing serial data signal 205 by altering the operations of phase-locked loop (PLL) circuit 210 (which may be considered to be part of TX serializer logic 208) using jitter logic 212 (which itself may be considered to be part of PLL 210). In particular, jitter logic 212 changes the operations of PLL 210 so as to inject jitter into the PLL output clock generated by PLL 210 for use within TX serializer logic 208 in serializing the outgoing parallel data signal received from mux 206. By selecting different amounts (e.g., magnitudes, rates) of jitter, the operations of the device can be tested using ATE equipment under a variety of different circumstances.

Note that, as described in further detail in the next section, external and internal jitter clocks 211 and 213 can be used to adjust the operations of PLL circuit 210, which adjustments result in jitter being injected into the PLL output clock. As such, clocks 211 and 213 may be said to be “jitter clocks,” because they are used to create jitter. Note that they might or might not have jitter themselves. Their significance is that they can be asynchronous from the PLL's reference clock (e.g., have a phase and/or frequency that differs from the PLL's conventional reference clock).

PLL Architecture

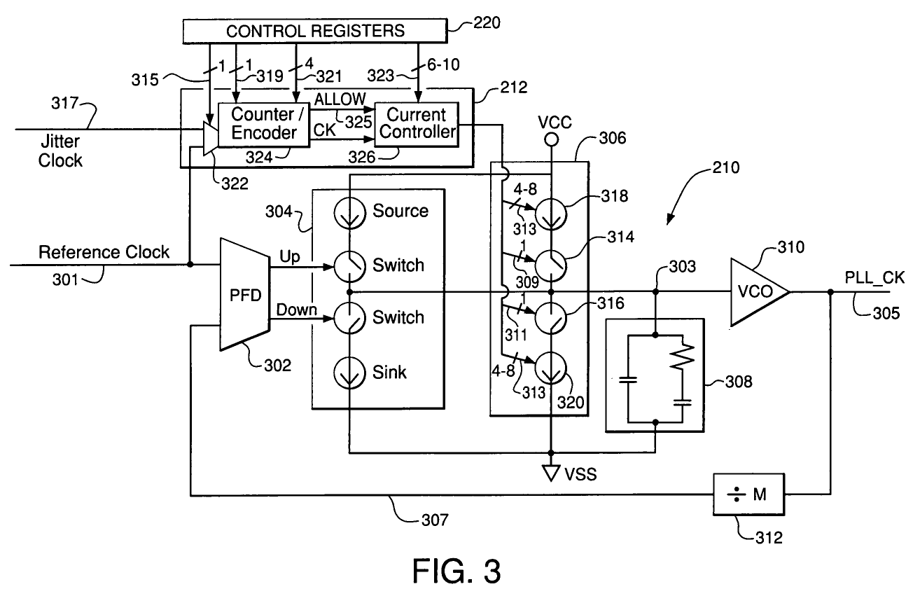

FIG. 3 shows a block diagram of control registers 220, jitter logic 212, and PLL circuit 210 of FIG. 2, according to one embodiment of the present invention. PLL 210 contains the following conventional PLL elements: phase/frequency detector (PFD) 302, charge pump 304, loop filter 308, voltage-controlled oscillator (VCO) 310, and feedback divider 312. In general, PLL generates an PLL output clock 305 having a fixed phase and frequency relationship with an applied PLL reference clock 301. In particular, when feedback divider 312 divides PLL output clock 305 by a factor of M, the frequency of PLL output clock 305 will be M times that of PLL reference clock 301, and PLL output clock 305 will be in phase with PLL reference clock 301 (e.g., each rising edge of PLL reference clock 301 will coincide with a rising edge of PLL output clock 305).

PFD 302 compares the phase of divided-down feedback clock 307 from feedback divider 312 with the phase of PLL reference clock 301. Depending on whether feedback clock 307 lags or leads PLL reference clock 301, PFD 302 generates UP and DOWN control signals that selectively close one of the switches within charge pump 304, thereby injecting or removing charge (via the corresponding current source/sink) from loop filter 308, thereby affecting the voltage at input node 303 of VCO 310. VCO 310 generates PLL output clock 305 having a frequency that depends on the voltage at VCO input node 303.

In addition to these standard PLL elements and operations, PLL 210 also has a programmable jitter circuit 306 comprising two switches (314 and 316) and corresponding programmable current devices (i.e., source 318 and sink 320). Depending on the particular implementation, switches 314 and 316 receive 1-bit control signals 309 and 311 from jitter logic 212, and programmable current devices 318 and 320 receive (e.g., the same or possibly different) multi-bit (e.g., 4- to 8-bit) control signal 313 from jitter logic 212, where control signal 313 determines the magnitude of the current setting for the programmable current devices. In one implementation, if control signal 309 has a logical value of one and control signal 311 has a logical value of zero, then switch 314 is closed and switch 316 is open, in which case the source current from current source 318 is added at node 303, thereby raising the voltage at node 303 and increasing the frequency of PLL output clock 305. If, on the other hand, control signal 309 has a logical value of zero and control signal 311 has a logical value of one, then switch 314 is open and switch 316 is closed, in which case the sink current from current sink 320 is removed from node 303, thereby lowering the voltage at node 303 and decreasing the frequency of PLL output clock 305. By changing the states of switches 314 and 316 and/or the magnitudes of the currents generated by source/sink devices 318 and 320, jitter logic 212 can cause PLL 210 to add jitter to its output clock 305.

As shown in FIG. 3, jitter logic 212 includes mux 322, counter/encoder 324, and current controller logic 326. Based on 1-bit control signal 315 from control registers 220, mux 322 applies either jitter clock 317 from mux 228 of FIG. 2 or PLL reference clock 301 to counter/encoder 324. The selected clock is used to control the timing of the processing of both counter/encoder 324 and current controller 326.

In addition, counter/encoder 324 receives 1-bit on/off control signal 319 and 4-bit encoder control signal 321 from control registers 220. Counter/encoder 324 uses these control signals to generate and apply a 1-bit control signal (ALLOW) 325 to current controller 326. If the on/off control signal 319 is a logical zero (i.e., off), then counter/encoder 324 sets and maintains the 1-bit ALLOW signal 325 to be low (logical zero). If on/off control signal 319 is a logical one (i.e., on), then counter/encoder 324 generates the value of the ALLOW signal 325 based on the value of 4-bit encoder control signal 321.

In one embodiment, the value (P) of 4-bit encoder control signal 321 dictates how many cycles the ALLOW signal 325 is high out of every 2^{N=4} or 16 clock cycles. For example, the value P=0 for control signal 321 would imply that the ALLOW signal 325 is high for one clock cycle out of every 16 clock cycles, while the value P=15 for control signal 321 would imply that the ALLOW signal 325 is high for all sixteen clock cycles, and similarly for the other 14 possible values for control signal 321. Exactly which cycles are selected in each 16-cycle period may depend on the particular implementation.

In other possible embodiments, control signal 321 could be used to control the value of the ALLOW signal 325 in different ways. For example, the value P of control signal 321 could dictate a pattern where the value of ALLOW signal 325 alternates between high and low at P-clock cycle intervals (i.e., P clock signals high followed by P clock signals low followed by P clock signals high, and so on).

Current controller 326, which receives 6- to 10-bit control signal 323 corresponding to 1-bit control signals 309 and 311 and multi-bit control signal 313, applies those control signals to switches 314 and 316 and current devices 318 and 320 whenever the ALLOW signal 325 corresponds to a logical one.

In one exemplary mode of operation, the values in control registers 220 are programmed such that mux 322 selects reference clock 301, counter/encoder sets the ALLOW signal 325 high based on the value of 4-bit encoder control signal 321, and current controller 326 asserts control signals 309, 311, and 313 whenever the ALLOW signal 325 is high. This mode of operation can be used to provide effective testing of devices prior to packaging (e.g., at the wafer stage) as well as at the package stage. Other modes of operation for injecting jitter into PLL output clock 305 based on the programmability of jitter logic 212 are also possible.

Although the present invention has been described in the context of a particular serdes application, the invention is not so limited. For example, the parallel signals serialized and generated by serdes circuits of the present invention may be other than 10-bit parallel signals. Similarly, encoder control signal 321 may have other than 4 bits, and programmable current devices 318 and 320 may have other numbers of programmable current levels. Furthermore, the outgoing and/or incoming serial signals need not be differential signals.

Although the present invention has been described in the context of a serdes application in which jitter is injected using programmable jitter circuit 306 of PLL 210 to add or subtract jitter charge to or from loop filter 308, the invention is not so limited. In general, there are other ways to inject jitter, such as by directly controlling VCO 310.

Although the present invention has been described in the context of a serdes internal loopback mode of operation in which jitter is added to the PLL output clock used by the serdes TX to generate a serdes output signal, which is internally looped back to the serdes RX, the invention is not so limited. In another application, the jitter-dependent serdes output signal can be applied to external devices (e.g., connected to output pads 216) to test the operations of those external devices in the presence of jitter. While the internal loopback mode enables testing at the wafer stage (e.g., to identify bad parts prior to the expense of packaging) and at the package stage (e.g., to identify bad parts prior to sale), the ability to operate in an “external loopback” mode (i.e., by appropriately controlling muxes 232) enables a user to perform system-level testing, in which the packaged device is configured (1) to provide a jitter-dependent serdes output signal, e.g., based on PRBS data signal 203, to external system components (e.g., system logic) via output pads 216 and (2) to receive a resulting serdes input signal from those external system components via input pads 230, where the data good flag generated by PRBS comparator 238 can be used to provide feedback for characterizing and possibly tuning the system configuration. Moreover, the present invention can be used to inject jitter into a PLL output clock that is applied to circuitry other than serdes circuits to test the operations of those other types of circuitry in the presence of jitter.

Although the present invention has been described in the context of FPGAs, those skilled in the art will understand that the present invention can be implemented in the context of other types of devices, such as, without limitation, application-specific integrated circuits (ASICs), programmable logic devices (PLDs), mask-programmable gate arrays (MPGAs), simple programmable logic device (SPLDs), and complex programmable logic devices (CPLDs). More generally, the present invention can be implemented in the context of any kind of electronic device having programmable elements.

The present invention may be implemented as circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro-controller, or general-purpose computer.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

It will be further understood that various changes in the details, materials, and arrangements of the parts which have been described and illustrated in order to explain the nature of this invention may be made by those skilled in the art without departing from the scope of the invention as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

We claim:

1. An integrated circuit having a serializer/de-serializer (serdes) comprising:
a transmitter adapted to serialize an outgoing parallel data signal to generate an outgoing serial data signal; and
a receiver adapted to de-serialize an incoming serial data signal to generate an incoming parallel data signal, wherein:
the serdes is adapted to support an internal loopback mode in which the outgoing serial data signal from the transmitter is internally looped back within the integrated circuit to the receiver as the incoming serial data signal; and
the transmitter is adapted to programmably inject jitter into the outgoing serial data signal.

2. The invention of claim 1, wherein the serdes supports internal loopback testing of an unpackaged integrated circuit at a wafer stage, internal loopback testing of a packaged integrated circuit at a package stage, and external loopback testing at a system level.

3. The invention of claim 1, wherein the transmitter comprises:
a phase-locked loop (PLL) adapted to generate a PLL output clock based on a PLL reference clock;
a serializer adapted to use the PLL output clock to serialize the outgoing parallel data signal to generate the outgoing serial data signal; and
jitter logic adapted to programmably control operations of the PLL to add jitter into the PLL output clock resulting in the jitter in the outgoing serial data signal.

4. The invention of claim 3, wherein the PLL comprises:
a voltage-controlled oscillator (VCO) adapted to generate the PLL output clock based on a voltage at an input node of the VCO;
a loop filter connected to generate the voltage at the VCO input node;
a charge pump connected to selectively add charge to or subtract charge from the loop filter;
a phase/frequency detector (PFD) adapted to compare a feedback clock based on the PLL output clock to a reference clock to generate pump control signals for controlling the charge pump; and
a programmable jitter circuit adapted to programmably add additional charge to or subtract additional charge from the loop filter based on jitter control signals received from the jitter logic.

5. The invention of claim 4, wherein the programmable jitter circuit comprises:
a programmable current source adapted to generate a programmable level of source current based on a multi-bit control signal received from the jitter logic;
a current-source switch connected to control whether a source current from the programmable current source is added at the VCO input node based on a first on/off control signal from the jitter logic;
a programmable current sink adapted to generate a programmable level of sink current based on the multi-bit control signal received from the jitter logic; and
a current-sink switch connected to control whether a sink current from the programmable current sink is removed from the VCO input node based on a second on/off control signal from the jitter logic.

6. The invention of claim 3, wherein the jitter logic is adapted to receive a clock and change the operations of the PLL as a function of the frequency of the received clock.

7. The invention of claim 6, wherein the received clock is based on an external clock received at an input pad of the integrated circuit.

8. The invention of claim 3, wherein the jitter logic is adapted to receive an N-bit encoder control signal having a value P and control operations of the PLL based on the value of the encoder control signal, such that, for P clock cycles out of every 2^{N} cycles of a jitter-logic clock, the jitter logic causes adjusted operations of the PLL.

9. The invention of claim 3, wherein the jitter logic comprises:
an input mux adapted to select one of a jitter clock and the PLL reference clock;
a counter/encoder adapted to receive the selected clock from the input mux, an on/off control signal, and an N-bit encoder control signal having a value P, wherein:
if the on/off control signal indicates that the counter/encoder is off, then the counter/encoder sets an allow control signal to be off; and
if the on/off control signal indicates that the counter/encoder is on, then the counter/encoder turns on and off the allow control signal based on the value P of the N-bit encoder control signal; and
a current controller adapted to control the operations of the PLL based on the allow control signal.

10. The invention of claim 9, wherein the PLL comprises:
a voltage-controlled oscillator (VCO) adapted to generate the PLL output clock based on a voltage at an input node of the VCO;
a loop filter connected to generate the voltage at the VCO input node;
a charge pump connected to selectively add charge to or subtract charge from the loop filter;
a phase/frequency detector (PFD) adapted to compare a feedback clock based on the PLL output clock to the PLL reference clock to generate pump control signals for controlling the charge pump; and
a programmable jitter circuit adapted to programmably add additional charge to or subtract additional charge from the loop filter based on jitter control signals received from the current controller of the jitter logic.

11. The invention of claim 10, wherein the programmable jitter circuit comprises:
a programmable current source adapted to generate a programmable level of source current based on a multi-bit control signal received from the current controller;
a current-source switch connected to control whether a source current from the programmable current source is added at the VCO input node based on a first on/off control signal from the current controller;
a programmable current sink adapted to generate a programmable level of sink current based on the multi-bit control signal received from the current controller; and
a current-sink switch connected to control whether a sink current from the programmable current sink is removed from the VCO input node based on a second on/off control signal from the current controller, wherein:
the current controller in the jitter logic receives the jitter control signals for the programmable jitter circuit and applies those jitter control signals whenever the allow control signal is on.

12. The invention of claim 1, wherein the integrated circuit is an FPGA.

13. An integrated circuit having a phase-locked loop (PLL) comprising:
a voltage-controlled oscillator (VCO) adapted to generate a PLL output clock based on a voltage at an input node of the VCO;
a loop filter connected to generate the voltage at the VCO input node;
a charge pump connected to selectively add charge to or subtract charge from the loop filter;
a phase/frequency detector (PFD) adapted to compare a feedback clock based on the PLL output clock to a PLL reference clock to generate pump control signals for controlling the charge pump;
a programmable jitter circuit adapted to programmably add additional charge to or subtract additional charge from the loop filter based on jitter control signals; and
jitter logic adapted to generate the jitter control signals to control operations of the programmable jitter circuit.

14. The invention of claim 13, wherein the programmable jitter circuit comprises:
a programmable current source adapted to generate a programmable level of source current based on a multi-bit control signal received from the jitter logic;
a current-source switch connected to control whether a source current from the programmable current source is added at the VCO input node based on a first on/off control signal from the jitter logic;
a programmable current sink adapted to generate a programmable level of sink current based on the multi-bit control signal received from the jitter logic; and
a current-sink switch connected to control whether a sink current from the programmable current sink is removed from the VCO input node based on a second on/off control signal from the jitter logic.

15. The invention of claim 13, wherein the jitter logic is adapted to receive a clock and change the operations of the programmable jitter circuit as a function of the frequency of the received clock.

16. The invention of claim 13, wherein the jitter logic is adapted to receive an N-bit encoder control signal having a value P and control operations of the programmable jitter circuit based on the value of the encoder control signal, such that, for P clock cycles out of every 2^{N} cycles of a jitter-logic clock, the jitter logic causes adjusted operations of the programmable jitter circuit.

17. The invention of claim 13, wherein the jitter logic comprises:
an input mux adapted to select one of a jitter clock and the PLL reference clock;
a counter/encoder adapted to receive the selected clock from the input mux, an on/off control signal, and an N-bit encoder control signal having a value P, wherein:
if the on/off control signal indicates that the counter/encoder is off, then the counter/encoder sets an allow control signal to be off; and
if the on/off control signal indicates that the counter/encoder is on, then the counter/encoder turns on and off the allow control signal based on the value P of the N-bit encoder control signal; and
a current controller adapted to control the operations of the programmable jitter circuit based on the allow control signal.

18. The invention of claim 17, wherein the programmable jitter circuit comprises:
a programmable current source adapted to generate a programmable level of source current based on a multi-bit control signal received from the jitter logic;
a current-source switch connected to control whether a source current from the programmable current source is added at the VCO input node based on a first on/off control signal from the jitter logic;
a programmable current sink adapted to generate a programmable level of sink current based on the multi-bit control signal received from the jitter logic; and
a current-sink switch connected to control whether a sink current from the programmable current sink is removed from the VCO input node based on a second on/off control signal from the jitter logic, wherein:
the current controller in the jitter logic receives the jitter control signals for the programmable jitter circuit and applies those jitter control signals whenever the allow control signal is on.

19. The invention of claim 13, wherein the integrated circuit is an FPGA.

20. A method for testing an integrated circuit having a serializer/de-serializer (serdes) comprising:
a transmitter adapted to serialize an outgoing parallel data signal to generate an outgoing serial data signal; and
a receiver adapted to de-serialize an incoming serial data signal to generate an incoming parallel data signal, wherein:
the serdes is adapted to support an internal loopback mode in which the outgoing serial data signal from the transmitter is internally looped back within the integrated circuit to the receiver as the incoming serial data signal; and
the transmitter is adapted to programmably inject jitter into the outgoing serial data signal, the method comprising:
configuring the serdes into the internal loopback mode; and
programming the transmitter to inject jitter into the outgoing serial data signal.
